(19) United States
(12) Patent Application Publication
(10) Pub. No.: US 2026/0359823 A1
(43) Pub. Date: Nov. 12, 2026

(54) NEXT-GENERATION RULE AUTOMATION SYSTEM AND METHODS BASED ON LARGE LANGUAGE MODELS

(71) Applicant: ACTIMIZE LTD., Ra'anana (IL)

(72) Inventors: Sunny THOLAR, Pune (IN); Ankush SHRIKHANDE, Pune (IN); Ankur PALIWAL, Pune (IN)

(21) Appl. No.: 19/201,391

(22) Filed: May 7, 2025

(51) Int. Cl. G06Q 20/40; G06Q 20/38

(52) U.S. Cl. CPC G06Q 20/4016; G06Q 20/389

(57) ABSTRACT

A fraud detection system and methods for detecting fraud include receiving historical financial transaction data; generating a prompt that comprises the historical financial transaction data labeled as legitimate or fraudulent or a description of one or more fraud patterns when the historical financial transaction data cannot be labeled as legitimate or fraudulent; executing the prompt via a large language model (LLM) to generate a plurality of fraud detection rules based on patterns the LLM identifies in the labeled historical financial transaction data or in the description of the one or more fraud patterns; evaluating a plurality of performance metrics of the plurality of generated fraud detection rules; selecting a plurality of generated fraud detection rules based on the evaluation of the plurality of performance metrics; receiving a real-time financial transaction; and applying, in real-time, the selected plurality of generated fraud detection rules to the real-time financial transaction.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to detecting fraud in financial transactions, and more specifically to systems and methods that leverage large language models (LLMs) to generate fraud detection rules.

### BACKGROUND

Fraudulent activities in various domains, such as financial transactions, e-commerce, and cybersecurity, evolve rapidly. Traditional fraud detection systems rely on predefined rule-based mechanisms to flag suspicious activities. However, these static rule-based approaches quickly become ineffective as fraudsters adapt and modify their tactics.

Existing fraud detection systems employ machine learning (ML) models to identify fraudulent activities. The primary challenges with existing fraud detection rule generation processes are that they are time-consuming and labor-intensive, are prone to errors, are not scalable, and are delayed with respect to new fraud patterns. Analysts manually interpret ML model outputs and define fraud rules, which significantly delays response times. Human interpretation introduces inconsistencies, leading to incomplete or inaccurate rule definitions. As fraud patterns evolve, updating rules requires repeated manual intervention, which is not sustainable for large-scale fraud detection systems. Since fraudsters continuously refine their tactics, static rules quickly become outdated, reducing their effectiveness.

Traditional fraud detection systems primarily rely on static, rule-based approaches or ML-driven fraud detection models that require extensive manual intervention for rule creation and updates. These existing methods suffer from limitations such as slow adaptation to emerging fraud tactics, error-prone rule formulation, and a lack of scalability.

Accordingly, there is a need for improved methods and systems for detecting fraud and generating fraud detection rules dynamically. This ensures real-time fraud detection rule generation with minimal human intervention.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a fraud detection system according to various aspects of the present disclosure.

FIG. 2A illustrates a prompt according to various aspects of the present disclosure.

FIG. 2B provides generated fraud detection rules in a text format according to various aspects of the present disclosure.

FIG. 2C provides generated fraud detection rules in the JSON format according to various aspects of the present disclosure.

FIG. 2D and FIG. 2E illustrate performance metrics of generated fraud detection rules according to various aspects of the present disclosure.

FIG. 2F illustrates a prompt for few shot learning according to various aspects of the present disclosure.

FIG. 3 illustrates a flowchart of a method according to various embodiments of the present disclosure.

FIG. 4 illustrates the results of ML-based rules versus LLM-based rules according to various embodiments of the present disclosure.

FIG. 5 is a block diagram of a computer system suitable for implementing one or more components in FIG. 1, according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods leverage the power of LLMs to revolutionize fraud alerting rules generation. The present disclosure automates the creation of interpretable fraud detection rules, saving time and increasing consistency in identifying patterns. The transactional data used to create the rules captures essential details like user behavior, transaction patterns, and geographical information. In various embodiments, the present invention combines clustering and customized ML models to tackle the diverse nature of fraud patterns.

Through advanced prompt engineering, the present invention guides the LLM to generate precise and actionable rules. The present disclosure leverages the LLM's pre-trained knowledge to create zero-shot or few-shot rules, enabling effective fraud alerting rules. This ensures the system is capable of detecting emerging fraud patterns even with limited historical data. These rules are rigorously evaluated to optimize accuracy, ensuring effective identification of fraudulent activities while minimizing false positives.

Traditional fraud detection requires analysts to manually analyze ML model outputs and define detection rules. This is labor-intensive, slow, and prone to errors. The present invention eliminates manual rule formulation by using LLMs to autonomously analyze ML model outputs and generate human-readable fraud detection rules. The rules are formulated in a structured, deployable format that can be directly integrated into fraud detection engines.

In addition, existing systems require periodic manual intervention to update fraud detection rules as fraud tactics evolve. The present disclosure provides a solution that dynamically refines detection rules in real-time based on continuous learning from new fraud patterns. By leveraging real-time fraud signals, the LLM adapts the rule set automatically, ensuring the fraud detection system remains proactive rather than reactive.

Furthermore, traditional fraud rule generation is time-consuming and difficult to scale, especially for large organizations handling massive transaction volumes. The present approach enables instantaneous rule generation by processing large-scale datasets in real-time, making it more highly scalable for enterprises.

Moreover, many existing systems generate excessive false positives, leading to unnecessary manual reviews and user inconvenience. By leveraging LLMs'advanced contextual understanding, the present system generates rules that balance fraud detection effectiveness with minimal false positives, improving operational efficiency.

Traditional fraud rule generation methods often require significant customization when integrating with existing ML-based fraud detection systems. The present invention offers an API-based or rule-extraction interface, allowing fraud detection models to seamlessly adopt and implement the generated rules without extensive modifications.

Advantageously, LLMs analyze ML model outputs, transaction data, and fraud patterns to autonomously generate detection rules. The present system formulates rules in human-readable formats that can be directly integrated into fraud detection engines. Moreover, the LLM continuously learns from new fraud trends, updating and refining detection rules dynamically. Rules are adjusted based on real-time fraud signals, ensuring ongoing accuracy. The present systems and methods eliminate the need for manual intervention, significantly reducing the time required to update fraud detection mechanisms, and can process large-scale datasets and generate rules in real-time. Furthermore, the present disclosure reduces human-induced errors by ensuring rules are formulated based on statistical patterns rather than subjective interpretation. The present systems and methods maintain uniformity in fraud detection across different environments. The present invention can be deployed alongside current ML-based fraud detection models, and provides an API-based or rule-extraction interface for seamless adoption into existing infrastructure.

As explained further below, the present system represents a dynamic, self-improving approach to fraud detection that leverages advanced artificial intelligence (AI) capabilities while maintaining human oversight and validation. It is designed to adapt to new fraud patterns and techniques as they emerge, providing a more robust defense against financial crime through increased fraud identification accuracy, speed, or both.

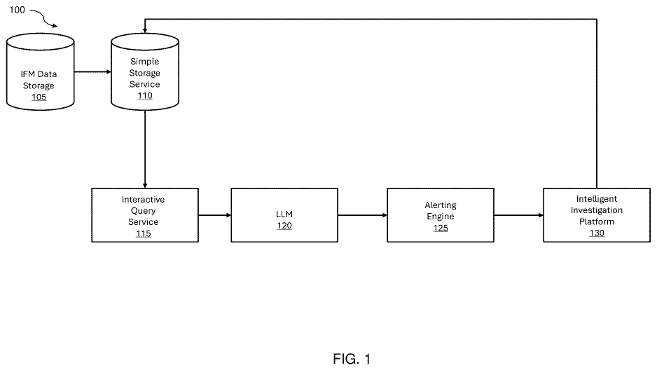

FIG. 1 illustrates a fraud detection system 100 according to various aspects of the present disclosure. The system 100 includes integrated fraud management (IFM) data storage 105, simple storage service 110, interactive query service 115, LLM 120, alerting engine 125, and intelligent investigation platform 130. In various embodiments, to improve the accuracy of fraud detection models, the system 100 prioritizes using recent transaction data provided by users (also referred to herein as clients). This data can be enriched with additional transaction attributes computed by a financial crime prevention platform, such as NICE's Actimize tool. The final dataset, combining recent transactions and computed attributes, is preferably used to develop advanced fraud detection models within the financial crime prevention platform.

To analyze fraud patterns, in this embodiment data is extracted from IFM database 105 for a period of 3-6 months. This extraction focuses on specific groups of events within client systems, called base activities, that help in profiling and detecting fraud. Base activities are essentially groupings of events within client systems, serving as a logical framework for profiling and detection purposes. For instance, a base activity may be “Web ACH Retail.”

Data from IFM data storage is stored in simple storage service 110, and then fed to interactive query service 115. Relevant information is collected from simple storage service (S3) 110 (e.g., Amazon S3), where data from multiple customers is stored. This data is filtered to select only the necessary details for analysis. This serves as the primary data repository, where financial transaction data, customer interactions, and fraud-related alerts are stored. It allows for scalable and secure storage of vast amounts of structured and unstructured financial data.

Simple storage service 110 stores a vast amount of transactional data, customer information, customer interactions, previous fraud alerts, and potentially historical fraud patterns. This database is the source of raw data for the entire fraud detection process. It holds the information needed to identify suspicious activities.

Raw transaction data is pulled from simple storage service 110 via interactive query service 115. Interactive query service 115 (e.g., Amazon Athena) enables SQL-based querying of data stored in simple storage service 110. Interactive query service 115 is used to retrieve specific transactional datasets from simple storage service 110 efficiently, without the need for a dedicated database infrastructure. This integration ensures that fraud detection rules are based on the latest available data.

In some embodiments, the extracted raw data is cleaned, normalized, and prepared for analysis to ensure data consistency and accuracy. Feature engineering may be performed to create meaningful attributes that improve fraud detection such as aggregated transaction features (e.g., total transactions per day per user), time-based attributes (e.g., frequency of high-volume transactions within a short period), and behavioral indicators (e.g., sudden changes in transaction amounts or new payees added). The preprocessing step ensures that that the input data is structured, high quality, and optimized for rule generation.

By utilizing simple storage service 110 and interactive query service 115, system 100 maintains a highly scalable and flexible architecture, capable of handling large data volume from multiple financial institutions or business units. The core functionality of system 100 revolves around a structured rule retuning process that ensures fraud detection rules remain effective and adaptive to new fraud trends. By continuously analyzing transaction-level data, the system 100 can identify patterns, anomalies, and potential fraudulent activities.

LLM 120 is used to generate new fraud detection rules based on the preprocessed data, historical fraud patterns, and a prompt or a set of instructions provided to the LLM 120. LLM 120 is provided with contextual information such as existing fraud detection rules that need refinement, recent fraud cases detected in the system 100, and patterns extracted from the latest transaction data. LLM 120 then applies advanced AI techniques, including few-shot and zero-shot learning, to derive meaningful fraud detection rules. These AI-generated rules are more adaptive and sophisticated compared to traditional manually written rules, as they provide for detection of non-obvious fraud patterns and relationships, more frequent adjustment, can account for newer trends and developments in fraudulent transactions, etc.

These fraud detection rules are formatted in a way that allows seamless integration into the fraud detection system 100. The newly generated rules are designed to detect emerging fraud tactics that were not previously identified, increase accuracy by reducing false positives and false negatives, and enhance adaptability to different customer profiles, transaction types, and fraud scenarios. The rules are sent to alerting engine 125 of an IFM integrated fraud platform.

Alerting engine 125 receives real-time transactions, and generates an alert when a transaction score of the transaction is greater than a threshold. The transaction score measures the likelihood of fraud of the transaction. Alerting engine 125 calculates the transaction score and sends the transaction score to intelligent investigation platform 130 (e.g., NICE Actimize's ActOne). Depending on the severity of the transaction score, intelligent investigation platform 130 may automatically allow the transaction, decline the transaction, or delay the transaction.

In this embodiment, a transaction is allowed when the transaction score is below the threshold, indicating a low fraud risk. In this case, the transaction is processed and allowed to proceed without any restrictions. A transaction is declined when the transaction score is significantly above the threshold, suggesting a high likelihood of fraud. The system 100 automatically declines the transaction to prevent potential financial losses. A transaction is delayed when the transaction score exceeds a specific level (but perhaps not as high as the automatic decline threshold). The transaction is flagged as suspicious, but the system 100 might hold it for a set period to allow a fraud analyst or a customer, or both, to review the details before making a final decision.

All alerts along with their corresponding transaction score are sent to the intelligent investigation platform 130. In various embodiments, intelligent investigation platform 130 includes a policy manager that allows clients to create rules using an intuitive user interface. The platform 130's advanced analytics identifies hidden relationships and explore networks to identify risks, ensuring a comprehensive understanding of fraud patterns. The policy manager take client configurability a step further by allowing a user to define thresholds that determine how aggressively the system 100 flags transactions for review. This empowers users to strike a balance between risk mitigation and customer experience.

In one or more embodiments, thresholds for a feature or combination of features can be defined by a user. For example, the user may set a threshold for a transaction amount of $10. Transactions below this amount would be considered lower risk, even if the transaction score generated by the system 100 is slightly above a predefined threshold. In this scenario, the system 100 would likely allow the transaction to proceed despite the alert. This allows the user to prioritize resources by focusing on higher-risk transactions that exceed the configured thresholds.

In the above example, if the transaction score is the same, but the transaction amount is very high like $1000, then the transaction may be delayed. A high-value transaction like a $1000 ATM withdrawal is likely more important to the user compared to a small withdrawal. A fraudulent high-value withdrawal could result in significant financial loss for the user. By monitoring high-value (and if needed, also the frequency of) ATM withdrawals, institutions can help mitigate the risk of being used for illicit purposes. Hence, in such cases, the transaction is delayed.

In the same example, if the ATM withdrawal is $10,000, the transaction is declined immediately. This transaction amount might be astronomically high compared to a customer's typical spending or withdrawal pattern of, for example, $100. The transaction may be accompanied by other red flags, such as originating from a known blacklisted location or involving a recently compromised account. This transaction is very high risk, exceeding the bank's usual tolerance level. When a transaction significantly surpasses the threshold of $10, intelligent investigation platform 130 automatically declines it without delay. This immediate action minimizes the potential for financial loss in case of fraudulent activity.

In certain embodiments, intelligent investigation platform 130 evaluates transactions based on a set of predefined features such as: (1) transaction amount-smaller transactions like a $10 ATM withdrawal may be considered less risky by default; (2) transaction location transactions originating from a familiar ATM location used by the customer frequently would be less suspicious than those from a high-risk geographic area; (3) customer behavior-the system 100 considers the customer's historical transaction patterns. A small withdrawal from an ATM may be normal for a customer who typically makes small, frequent withdrawals, but highly unusual for someone who usually makes large purchases; and/or (4) device characteristics transactions from unrecognized devices or those known to be associated with fraudulent activity would raise a red flag.

In an exemplary workflow for system 100, the data is first sampled. In one embodiment, the Bernouli sampling method is used. The Bernouli sampling method is a sampling process where each element of the population is subjected to an independent Bernouli trial which determines whether the element becomes part of the sample. In such a sampling, every member of the population has the same probability of selection.

### Customer Data Availability and Extraction

As part of the sampling process in this embodiment, clients from the same base activity are identified. Data, from these clients for the same base activity, e.g., customer transaction and statistics data, is then extracted from IFM data storage 105. This database is the source of raw data for the fraud detection process. It holds information such as party static details, account details, and transaction details. Using the Panda and NumPy libraries, which are Python libraries that help in data manipulation, cleaning and analysis, the data is filtered and only the relevant information that is needed for model training is retrieved.

Data from IFM data storage 105 is pushed to simple storage device 110. The data essential for analysis originates from simple storage device 110, a secure and scalable object storage service. Within the simple storage device 110, a wealth of customer information is housed, encompassing a diverse range of data types. This includes static customer data, such as demographic details and contact information, historical behavioral profiles, which capture past interactions and preferences, and recent transaction data, which provides insights into current patterns. This data undergoes filtering processes to extract relevant information based on specific criteria.

In some embodiments, to enhance the sophistication of the models, the system 100 prioritizes the use of recent data shared by clients. This recent transaction data is augmented with transaction attributes computed by a platform for financial crime prevention, to create a comprehensive dataset for model development analysis. This dataset serves as the foundation for developing advanced analytics within the platform.

### Data Filtration

Once the data is gathered, the data is prepared by cleaning, transforming, and organizing the data into a format suitable for analysis. Raw data is often messy and inconsistent. Data preparation ensures that the information is accurate, complete, and in a structure that the LLM 120 can more easily ingest and understand. Data cleaning involves removing errors, handling missing values, and standardizing the data format. The quality of input data and the accuracy of data processing are often paramount for building high quality models. To achieve this, data cleaning procedures are employed to minimize, or preferably eliminate any, unreliable or inconsistent data. Additionally, certain input data may require transformation into numerical values to facilitate their incorporation into the final model equation.

Transactions that have undergone filtering processes and are deemed unnecessary for model development are excluded from consideration. Filters, in this context, represent technical rules or business rules applied to evaluate incoming transactions. The purpose of these filter rules is to streamline transaction processing by determining whether a transaction requires further assessment by a LLM model. The process involves gathering data from various sources, extracting relevant information based on predefined criteria, including a comprehensive set of features for model development, and applying filtering rules to streamline transaction processing before model evaluation. This approach ensures that the LLM model is trained on a robust dataset, optimizing its effectiveness in fraud detection and prevention.

To maintain the integrity of the model development process, quality control or data validation checks are performed on the dataset. These checks aim to identify any anomalies or issues that could potentially compromise the quality of the model. Any issues detected during the data gathering phase are addressed promptly to ensure the robustness and reliability of the model. Utilization of the recent data combined with the attributes allows for the creation of more advanced models. Ensuring data quality through cleaning procedures and validation checks is essential for developing accurate and reliable fraud detection models.

### Exploratory Data Analysis (EDA)

After extraction and filtration, data scientists and analysts analyze the data using exploratory data analysis (EDA) to help develop the LLM model]. This involves filtering and identifying the base activities and types of transactions for further analysis. This step generally uses the Xsight algorithm. Xsight helps in performing deeper statistical analysis and visualizations to identify fraud patterns or trends in the data.

Data cleaning is generally part of EDA. During data cleaning, missing values within the dataset are identified and handled. Missing values can adversely affect model performance, so techniques like imputation (filling missing values with estimated ones) or deletion (removing rows or columns with missing values) are applied. In addition, features with zero variance, meaning they have constant values across all samples, are identified and removed from the dataset. These features do not contribute any meaningful information to the model and can be safely dropped. Features having more categories (e.g., those having a default threshold of over 50) are identified and removed from the dataset. These features can create a large number of dummy variables and reduce model performance. Features that are specific to certain clients or regions and do not generalize well across the dataset are dropped. This ensures that the model remains robust and applicable to diverse data scenarios.

Basic EDA involves both fraud distribution and feature distribution. Fraud distribution includes checking the fraud distribution across the different time periods to ensure sufficient fraud availability for model training. Feature distribution includes analyzing the feature distribution for each variable using the following: numerical features (e.g., minimum, maximum, mean, standard deviation, and distinct count and categorical features (e.g., fraud rate and legitimate rate of each categorical feature).

Fraud enrichment is also a part of EDA and is a process of augmenting data with additional fraud labels obtained from existing information related to fraudulent transactions. This is achieved by rectifying mislabeled transactions that were erroneously tagged as legitimate instead of fraudulent by bank analysts. In fraud detection, having more data on fraudulent activities enhances the accuracy of risk calculations. Fraud enrichment is carried out based on an analysis of transactions closely associated with fraudulent ones, typically determined by certain business logic metrics, such as transactions involving the same payee entity.

Legitimate transactions occurring within a day before or after a fraudulent transaction from the same device key are typically labeled as enriched fraud. Legitimate transactions involving the same payee entity as a fraudulent transaction are labeled as enriched fraud. Legitimate transactions linked to the same party key as fraudulent transactions from the same device key are labeled as fraud.

After fraud enrichment, results of fraud enrichment need to be validated and it needs to be ensured that not too many fraud cases are being unnecessarily added to avoid noise, which will impact model performance.

### Feature Engineering and Feature Selection

Feature engineering involves generating new, meaningful variables from the raw data that can be used to better identify fraudulent patterns. For example, one or more time-based features such as date duration (difference between two date columns), weekdays/weekends (calculating whether the date is falling on a weekday or weekend), and time bucket (whether the transaction is happening in morning, noon, or night) may be created. Other features that may be generated include a ratio feature (ratio between two features sometimes provide significant insight instead of individual special ratio for amount and balance features), one hot encoding (creating new binary columns, indicating the presence of each possible value from the original categorical data), and log transformation (each variable is replaced with it logarithm which will be helpful to make feature distribution more symmetric and reduce skewness). Numerous other meaningful variables may be included in addition to or as an alternative for those described above.

In feature selection, a feature selection algorithm is used. For example, the XGBoost model provides a significant list of features. The Boruta algorithm allows the creation of a ranking of the features, from the most important to the least impacting for the model. Min-redundancy max-relevance is an algorithm that ranks features based on their importance in predicting the target variable, where importance has a relevance and redundancy component. In one embodiment, the XGBoost algorithm is used to select the features as it is the most stable and provides a good fit. The final list of the features are reviewed by a subject matter expert, and based on feedback, the final list of features are adjusted.

### LLM-Based Rule Generation

Once the data is prepared, transactions can be labeled as legitimate or fraudulent. Legitimate transactions are those known to be genuine, while fraudulent transactions have been identified as fraudulent. The labeled data is important for training the LLM model. The model learns the patterns and characteristics that distinguish legitimate transactions from fraudulent ones.

In addition to the labeled transactions, the LLM 120 is also provided a prompt, which acts as the core of the fraud detection system 100. The prompt guides the LLM 120 on what to do and incorporates preprocessed data.

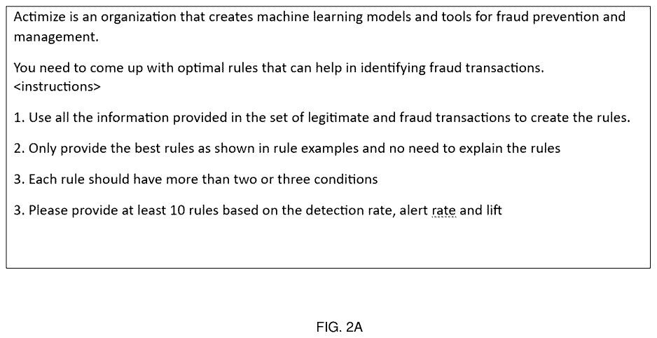

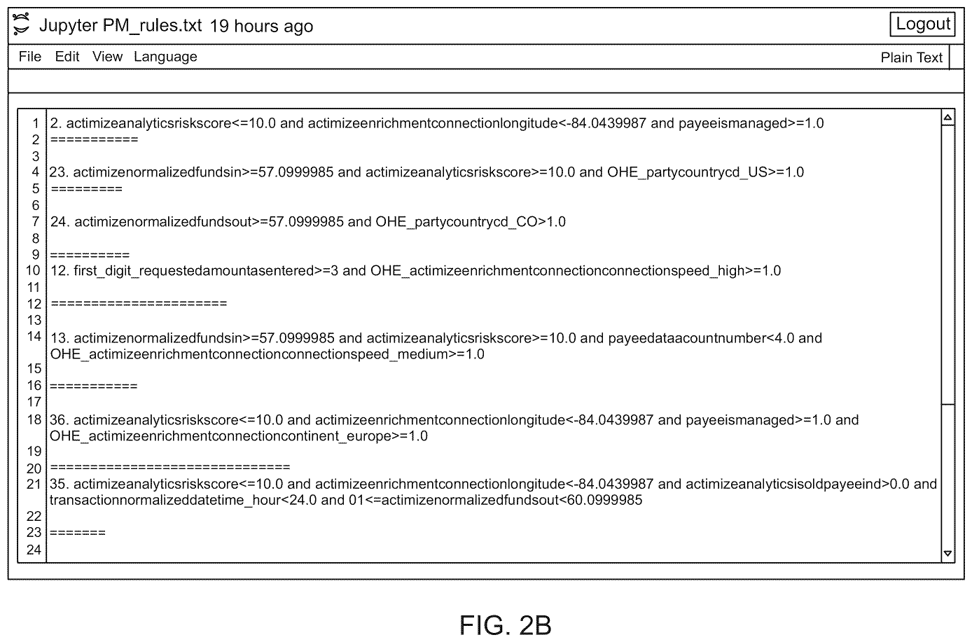

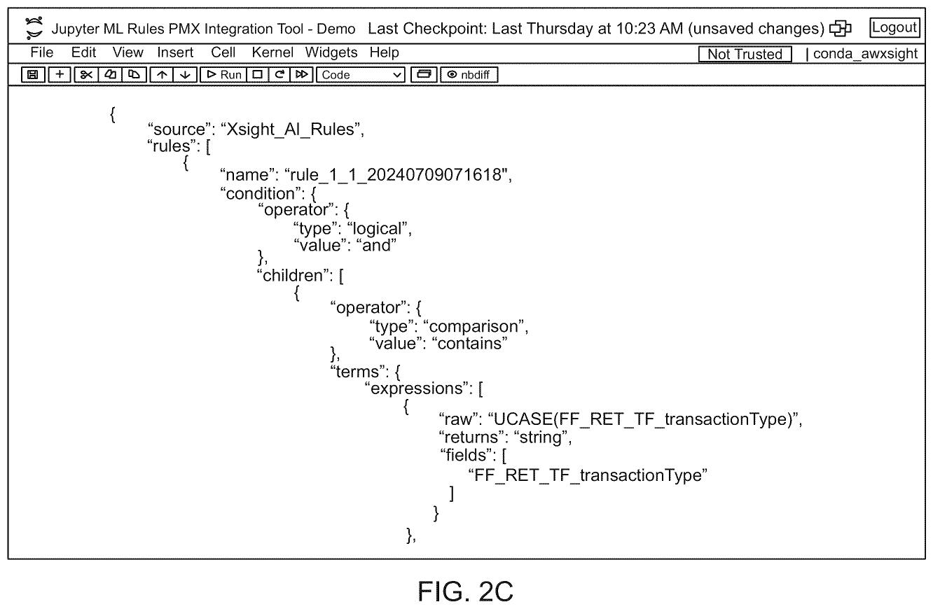

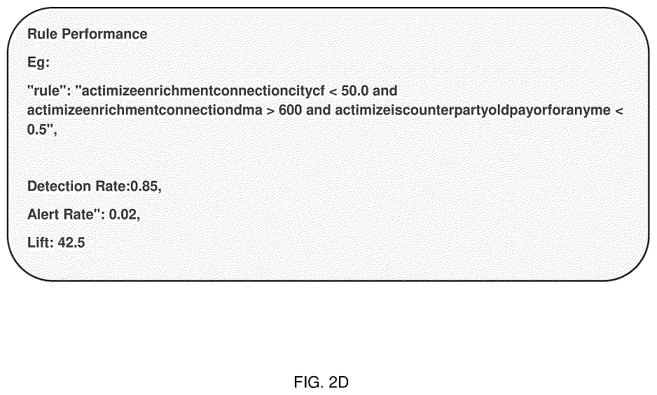

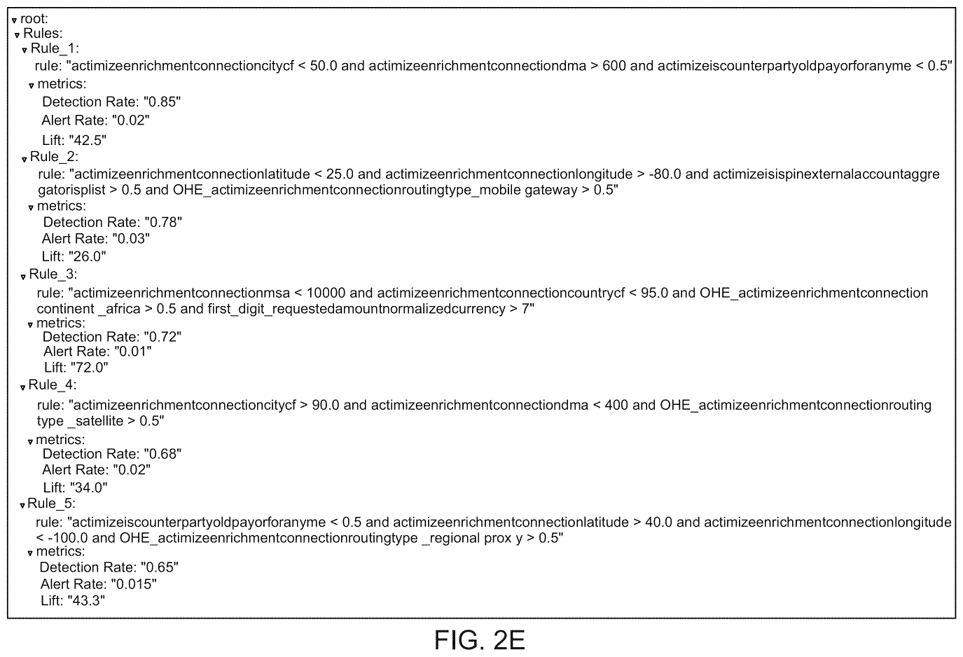

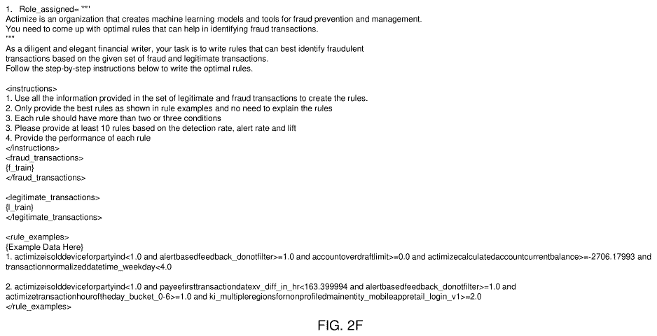

FIG. 2A is an example of a prompt. In this case, the prompt instructs the LLM 120 to: (1) use the provided legitimate and fraudulent transactions to create fraud detection rules, (2) generate rules in a specific format, (3) ensure each rule has multiple conditions, and (4) provide at least 10 rules based on performance metrics such as detection rate, alert rate, and lift.

Claude is an exemplary LLM 120 that can be used in system 100. LLMs are advanced AI models capable of understanding and generating human-like text, and in this context, they can learn patterns and create logical rules. The LLM 120 is the engine that processes the data and the prompt to generate the fraud detection rules. It analyzes the transactions, identifies patterns, and translates those patterns into actionable rules.

Each rule is a set of conditions that, when met, indicate a transaction might be fraudulent. The example rule provided below shows a combination of conditions related to geographic location, device type, and other factors.
Example Rule:
“actimizeenrichmentconnectioncitycf<50.0 and actimizeenrichmentconnectiondma>600 and actimizeiscounterpartyoldpayorforanyme<0.5”

The rules generated by the LLM model are formatted and stored in a JSON format, which is a structured format suitable for system integration. The system 100, in one embodiment, uses Python 3.10 for scripting and processing the generated rules. Python is utilized for rule manipulation, storing them in the required format, and passing them for further action.

FIG. 2B shows example rules that are generated in the text format and that will be further processed into the required format, e.g., JSON format. FIG. 2C is an example of rules in the JSON format.

### Rule Validation

Once the rules are generated, they are typically evaluated for effectiveness. Performance of the rules using metrics like detection rate, alert rate, and lift are measured. Detection rate is the percentage of actual fraud cases correctly identified. The alert rate is the percentage of legitimate transactions incorrectly flagged as fraudulent (false positives). Lift is a measure of how much better the rules perform compared to random chance. FIG. 2D shows a detection rate of 0.85, an alert rate of 0.2, and a lift of 42.5, indicating that the rules are effective at detecting fraud with a low false positive rate. FIG. 2E shows additional rules and their performance metrics.

The generated rules are tested against known historical data to assess their effectiveness. Rules that prove effective are implemented, and their performance is monitored to enable ongoing refinement.

### Feedback Loop

The best performing rules are chosen based on their performance metrics as described herein. Not all generated rules may be equally effective. Rule selection ensures that only the most accurate and efficient rules (or combination of rules) are used in the actual fraud detection system 100. Performance metrics such as detection accuracy, false positive rates, and flagged transaction effectiveness are collected by intelligent investigation platform 130. This feedback is then provided to simple storage device 110 and used to inform future data preprocessing and LLM training, ensuring that the system 100 evolves in response to new fraud patterns.

The feedback loop is crucial in that it connects rule validation back to the LLM-based rule generation. It allows system 100 to learn from its successes and failures, continuously improving the accuracy of fraud detection over time. Once the updated fraud detection rules are implemented, intelligent investigation platform 130 continuously monitors their performance in real-world scenarios.

In one or more embodiments, alerting engine 125 receives the fraud detection rules and the policy manager within intelligent investigation platform 130 determines what action to take for each transaction. Java is the language used here to receive the rules in the JSON format and to validate the rules. Java is used to implement business logic and manage how the rules interact with the fraud detection engine. Based on the generated rules, the system 100 takes actions such as allowing, delaying, or declining the transaction, depending on its score or risk level.

The present systems and methods leverage LLMs along with few-shot and zero-shot learning techniques to dynamically generate fraud detection rules. The system 100 is designed to operate efficiently under different data availability conditions, ensuring adaptability and robustness in fraud detection. The generated rules are then implemented in a fraud detection platform, to enable real-time fraud monitoring and prevention.

### Few-Shot Learning

In situations where a clean, labeled dataset of fraud instances is available, the fraud detection process follows a few-shot learning approach. The dataset consists of well-structured and preprocessed transactions where fraudulent activities have been explicitly marked. The advantage of using clean, labeled data is that the system 100 can directly learn from real-world fraud cases, making the detection process more precise and efficient.

Few-shot learning is a ML technique that enables models to learn from a small number of labeled examples. Unlike traditional deep learning models, which require vast amounts of training data, few-shot learning allows the model to generalize patterns effectively even with limited labeled data. This is particularly useful in fraud detection, where labeled fraud cases might be scarce but highly valuable.

Once the few-shot learning process is completed, an engineered prompt is generated. FIG. 2F illustrates a prompt for few-shot learning. This prompt is designed to guide the LLM 120 in extracting relevant fraud detection rules based on patterns identified in the labeled data. The prompt formulation is crucial because it acts as the intermediary between the learning model and the rule generation process, ensuring that the AI-driven rules are meaningful and applicable within the fraud detection framework.

### Zero-Shot Learning

In cases where no labeled fraud data is available or when historical financial transaction data cannot be labeled as legitimate or fraudulent, such as in new markets or when facing novel types of fraud, the system 100 employs zero-shot learning. This scenario presents a greater challenge because the model must make inferences without having seen explicit fraud examples during training.

Zero-shot learning enables the model to detect fraud even when it has not been provided with specific labeled fraud instances. Instead of relying on prior training on known fraud cases, the model utilizes its pre-trained knowledge and general understanding of fraudulent behaviors. It can infer patterns based on transaction characteristics, behavior anomalies, and linguistic cues from contextual data.

Given the absence of labeled data, a different engineered prompt is designed specifically for this scenario. The prompt incorporates general descriptions of fraud patterns, suspicious behaviors, and risk indicators. By structuring the prompt effectively, the LLM 120 can generate fraud detection rules that are applicable even in situations where explicit fraud labels are unavailable.

Both engineered prompts, generated from the few-shot and zero-shot learning, are then fed into an LLM 120. The LLM 120 processes these prompts using its extensive pre-trained knowledge and linguistic capabilities to formulate a set of fraud detection rules. Unlike traditional rule-based systems, which require manual coding and frequent updates, the use of LLM 120 allows for an automated, adaptive approach where rules are dynamically generated and refined based on evolving fraud patterns.

LLM 120 leverages natural language understanding and contextual reasoning to ensure that the generated rules are not only accurate but also interpretable. This eliminates the need for extensive manual intervention, significantly improving the efficiency and scalability of fraud detection processes.

Once the LLM 120 generates the fraud detection rules, they are integrated into fraud detection system 100, which is designed to monitor transactions and detect fraudulent activities in real time. The system 100 continuously applies the generated rules to incoming transaction data, flagging suspicious activities based on the defined fraud indicators. Since fraud tactics evolve rapidly, system 100 is designed to support real-time rule updates, ensuring that the detection mechanisms remain effective against new and emerging fraud patterns. By automating the entire rule generating and implementation process, system 100 enhances fraud detection capabilities while minimizing the time and effort required for manual rule updates.

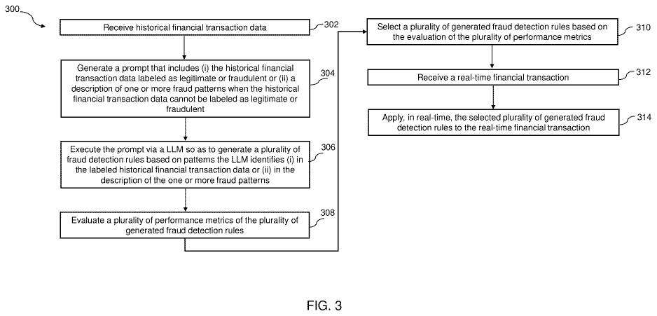

FIG. 3 illustrates a method 300 for detecting fraud in financial transactions according to embodiments of the present disclosure. At step 302, the system 100 receives historical financial data from simple storage service 110. In several embodiments, the historical financial data includes transaction data, customer information, fraud patterns, or any combination thereof.

At step 304, the system 100 generates a prompt that includes (i) the historical financial transaction data labeled as legitimate or fraudulent or (ii) a description of one or more fraud patterns when the historical financial transaction data cannot be labeled as legitimate or fraudulent. In embodiments where labeled data is available (i.e., few shot learning), the method 300 further includes labeling a plurality of financial transactions in the historical financial transaction data as legitimate or fraudulent, and training the LLM 120 on the labeled plurality of financial transactions. In various embodiments, the prompt further includes instructions to generate the fraud detection rules in a specific format, ensure each generated fraud detection rule includes a plurality of conditions, and provide a plurality of fraud detection rules and their respective values of the plurality of performance metrics, or any combination thereof.

At step 306, the system 100 executes the prompt via the LLM 120 so as to generate a plurality of fraud detection rules based on patterns the LLM identifies (i) in the labeled historical financial transaction data or (ii) in the description of the one or more fraud patterns. In some embodiments, each generated fraud detection rule includes a set of conditions that, when met, label a transaction as fraudulent.

At step 308, the system 100 evaluates a plurality of performance metrics of the plurality of generated fraud detection rules. In one or more embodiments, the performance metrics include two or more of a detection rate, an alert rate, and a lift.

At step 310, the system 100 selects a plurality of generated fraud detection rules based on the evaluation of the plurality of performance metrics. In an exemplary embodiment, the plurality of performance metrics are provided to the LLM 120 as feedback on the plurality of generated fraud detection rules.

At step 310, the system 100 receives a real-time financial transaction.

At step 312, the system 100 applies, in real-time, the selected plurality of generated fraud detection rules to the real-time financial transaction.

In one or more embodiments, the method 300 includes determining what action to take on the real-time financial transaction after application of the selected plurality of generated fraud detection rules to the real-time financial transaction. In some embodiments, the action includes allowing, delaying, or declining the real-time financial transaction.

In certain embodiments, the method 300 includes calculating a transaction score for the real-time financial transaction based on the application of the selected plurality of generated fraud detection rules to the real-time financial transaction, and generating an alert when the transaction score is greater than a predefined threshold transaction score.

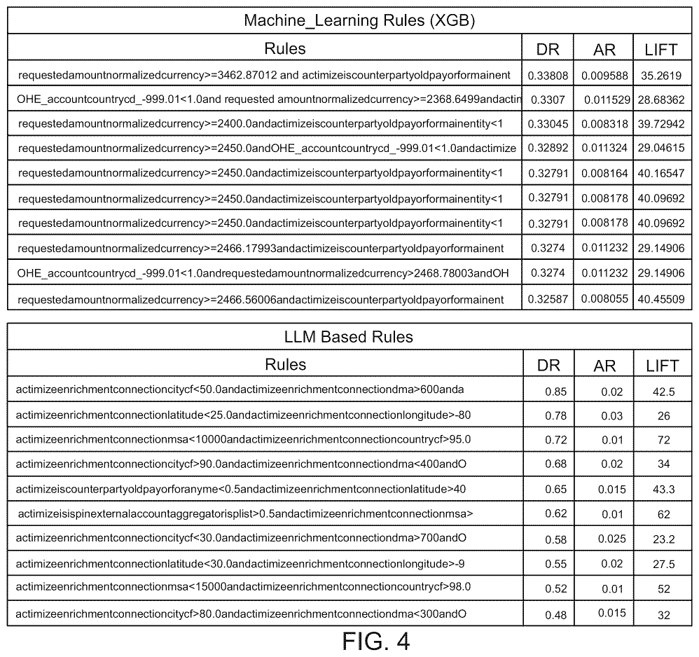

FIG. 4 provides the performance metrics of detection rate, alert rate, and lift for rules generated by machine learning and rules generated according to the present disclosure. The results in FIG. 4 demonstrate that the present invention is promising, and the rules generated using the LLM 120 are better than the traditional way of generating rules. While the time to generate the rules is not significant as the rules are not required in real-time, the present invention saves time (down from about an hour to a few minutes) and manual effort when compared to a ML rules generator.

The present systems and methods are the first-of-its-kind integration of LLMs into fraud rule generation that eliminates manual effort. They provide real-time adaptability to evolving fraud techniques, unlike traditional static rule-based systems. Human-readable, explainable fraud detection rules are generated automatically, reducing reliance on expert intervention. They also provide a scalable and efficient approach to processing vast amounts of transactional data without substantively compromising accuracy. By automating, optimizing, and continuously improving fraud detection rules using LLMs, the present invention represents a paradigm shift in fraud detection technology, making it significantly more efficient, scalable, and accurate than existing solutions.

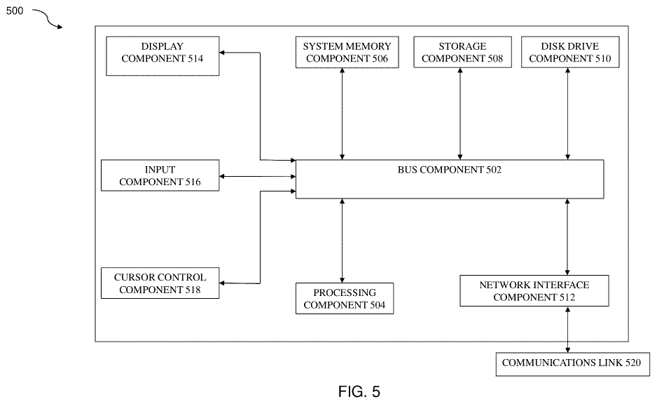

Referring now to FIG. 5, illustrated is a block diagram of a system 500 suitable for implementing embodiments of the present disclosure. System 500, such as part a computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer-readable medium, such as static storage component 508. These may include instructions to receive historical financial transaction data; generate a prompt that comprises the historical financial transaction data labeled as legitimate or fraudulent or a description of one or more fraud patterns when the historical financial transaction data cannot be labeled as legitimate or fraudulent; execute the prompt via a large language model (LLM) to generate a plurality of fraud detection rules based on patterns the LLM identifies in the labeled historical financial transaction data or in the description of the one or more fraud patterns; evaluate a plurality of performance metrics of the plurality of generated fraud detection rules; select a plurality of generated fraud detection rules based on the evaluation of the plurality of performance metrics; receive a real-time financial transaction; and apply, in real-time, the selected plurality of generated fraud detection rules to the real-time financial transaction. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A fraud detection system comprising:
a processor and a non-transitory computer readable medium operably coupled thereto, the non-transitory computer readable medium comprising a plurality of instructions stored in association therewith that are accessible to, and executable by, the processor, to perform operations which comprise:
receiving historical financial transaction data;
generating a prompt that comprises (i) the historical financial transaction data labeled as legitimate or fraudulent or (ii) a description of one or more fraud patterns when the historical financial transaction data cannot be labeled as legitimate or fraudulent;
executing the prompt via a large language model (LLM) so as to generate a plurality of fraud detection rules based on patterns the LLM identifies (i) in the labeled historical financial transaction data or (ii) in the description of the one or more fraud patterns;
evaluating a plurality of performance metrics of the plurality of generated fraud detection rules;
selecting a plurality of generated fraud detection rules based on the evaluation of the plurality of performance metrics;
receiving a real-time financial transaction; and
applying, in real-time, the selected plurality of generated fraud detection rules to the real-time financial transaction.

2. The fraud detection system of claim 1, wherein the historical financial transaction data comprises transaction data, customer information, fraud patterns, or any combination thereof.

3. The fraud detection system of claim 1, wherein the operations further comprise:
labeling a plurality of financial transactions in the historical financial transaction data as legitimate or fraudulent; and
training the LLM on the labeled plurality of financial transactions.

4. The fraud detection system of claim 1, wherein the prompt further comprises instructions to generate the fraud detection rules in a specific format, ensure each generated fraud detection rule comprises a plurality of conditions, provide a plurality of fraud detection rules and their respective values of the plurality of performance metrics, or any combination thereof.

5. The fraud detection system of claim 1, wherein each generated fraud detection rule comprises a set of conditions that, when met, label a transaction as fraudulent.

6. The fraud detection system of claim 1, wherein the plurality of performance metrics comprise two or more of a detection rate, an alert rate, and a lift.

7. The fraud detection system of claim 1, wherein the operations further comprise determining what action to take on the real-time financial transaction after application of the selected plurality of generated fraud detection rules to the real-time financial transaction.

8. The fraud detection system of claim 7, wherein the action comprises allowing, delaying, or declining the real-time financial transaction.

9. The fraud detection system of claim 1, wherein the operations further comprise:
calculating a transaction score for the real-time financial transaction based on the application of the selected plurality of generated fraud detection rules to the real-time financial transaction; and
generating an alert when the transaction score is greater than a predefined threshold transaction score.

10. The fraud detection system of claim 1, wherein the operations further comprise providing values of the plurality of performance metrics to the LLM as feedback on the plurality of generated fraud detection rules.

11. A method of detecting fraud in financial transactions, which comprises:
receiving historical financial transaction data;
generating a prompt that comprises (i) the historical financial transaction data labeled as legitimate or fraudulent or (ii) a description of one or more fraud patterns when the historical financial transaction data cannot be labeled as legitimate or fraudulent;
executing the prompt via a large language model (LLM) so as to generate a plurality of fraud detection rules based on patterns the LLM identifies (i) in the labeled historical financial transaction data or (ii) in the description of the one or more fraud patterns;
evaluating a plurality of performance metrics of the plurality of generated fraud detection rules;
selecting a plurality of generated fraud detection rules based on the evaluation of the plurality of performance metrics;
receiving a real-time financial transaction; and
applying, in real-time, the selected plurality of generated fraud detection rules to the real-time financial transaction.

12. The method of claim 11, which further comprises:
labeling a plurality of financial transactions in the historical financial transaction data as legitimate or fraudulent; and
training the LLM on the labeled plurality of financial transactions.

13. The method of claim 11, which further comprises determining what action to take on the real-time financial transaction after application of the selected plurality of generated fraud detection rules to the real-time financial transaction.

14. The method of claim 13, wherein the action comprises allowing, delaying, or declining the real-time financial transaction.

15. The method of claim 11, which further comprises providing values of the plurality of performance metrics to the LLM as feedback on the plurality of generated fraud detection rules.

16. A non-transitory computer-readable medium having stored thereon computer-readable instructions executable by a processor to perform operations which comprise:
receiving historical financial transaction data;
generating a prompt that comprises (i) the historical financial transaction data labeled as legitimate or fraudulent or (ii) a description of one or more fraud patterns when the historical financial transaction data cannot be labeled as legitimate or fraudulent;
executing the prompt via a large language model (LLM) so as to generate a plurality of fraud detection rules based on patterns the LLM identifies (i) in the labeled historical financial transaction data or (ii) in the description of the one or more fraud patterns;
evaluating a plurality of performance metrics of the plurality of generated fraud detection rules;
selecting a plurality of generated fraud detection rules based on the evaluation of the plurality of performance metrics;
receiving a real-time financial transaction; and
applying, in real-time, the selected plurality of generated fraud detection rules to the real-time financial transaction.

17. The non-transitory computer-readable medium of claim 16, wherein the operations further comprise determining what action to take on the real-time financial transaction after application of the selected plurality of generated fraud detection rules to the real-time financial transaction.

18. The non-transitory computer-readable medium of claim 17, wherein the action comprises allowing, delaying, or declining the real-time financial transaction.

19. The non-transitory computer-readable medium of claim 16, wherein the operations further comprise:
calculating a transaction score for the real-time financial transaction based on the application of the selected plurality of generated fraud detection rules to the real-time financial transaction; and
generating an alert when the transaction score is greater than a predefined threshold transaction score.

20. The non-transitory computer-readable medium of claim 16, wherein the operations further comprise providing values of the plurality of performance metrics to the LLM as feedback on the plurality of generated fraud detection rules.
